(19) United States
(12) Patent Application Publication
(10) Pub. No.: US 2025/0159642 A1
(43) Pub. Date: May 15, 2025

(54) METHOD AND UE FOR HANDLING TIMER EXPIRY DURING ONGOING NAS PROCEDURE IN WIRELESS NETWORK

(71) Applicant: Samsung Electronics Co., Ltd., Suwon-si, Gyeonggi-do (KR)

(72) Inventors: Danish Ehsan HASHMI, Bangalore (IN); Arijit SEN, Bangalore (IN); Koustav ROY, Bangalore (IN); Lalith KUMAR, Bangalore (IN)

(21) Appl. No.: 18/727,024

(22) PCT Filed: Jan. 6, 2023
(86) PCT No.: PCT/KR2023/000326

§ 371 Date: Jul. 5, 2024

(30) Foreign Application Priority Data
Jan. 6, 2022 (IN) 202241000739
Dec. 24, 2022 (IN) 2022 41000739

(51) Int. Cl. H04W 60/06; H04L 69/28; H04W 48/18; H04W 84/04

(52) U.S. Cl. CPC H04W 60/06; H04L 69/28; H04W 48/18; H04W 84/042

(57) ABSTRACT

The disclosure relates to a 5G or 6G communication system for supporting a higher data transmission rate. Embodiments herein provide a method for handling timer expiry during an ongoing non-access stratum (NAS) procedure in a wireless network by a UE. The method includes detecting that a last running first timer is stopped or expired. Further, the method includes performing a deregistration procedure by sending a deregistration request message to a network entity in the wireless network when the last running first timer is stopped or expired. Further, the method includes starting a second timer. Further, the method includes determining that the deregistration procedure is not successful in first attempt. Further, the method includes aborting the ongoing deregistration procedure upon determining that the deregistration procedure is not successful in the first attempt. The method can be used to ensure that the UE registers over higher priority PLMN without any delay and extra signalling.

### CROSS-REFERENCE TO RELATED APPLICATION(S)

This application is a U.S. National Stage application under 35 U.S.C. § 371 of an International application number PCT/KR2023/000326, filed on Jan. 6, 2023, which is based on and claims priority of an Indian patent application Ser. No. 20/224,1000739, filed on Jan. 6, 2022, in the Indian Intellectual Property Office, and of an Indian patent application Ser. No. 20/224,1000739, filed on Dec. 24, 2022, in the Indian Intellectual Property Office, the disclosure of each of which is incorporated by reference herein in its entirety.

### TECHNICAL FIELD

The disclosure relates to a wireless network, and more particularly related to a user equipment (UE) and a method to handle a Tsor-cm timer expiry during an ongoing non access stratum (NAS) procedure in the wireless network.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6 G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6 G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6 G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The 3^{rd} generation partnership project (3GPP) release 17 defined steering of roaming in connected mode control information (SOR-CMCI). When a user equipment (UE) receives a steering of roaming (SOR) information, the UE starts Tsor-cm timer for releasing connection when the UE is in a connected mode. After the connection is released, the UE initiate a high priority public land mobile network (PLMN) search.

FIG. 1A illustrating a scenario of Tsor-cm time expires during an ongoing registration process, according to the prior arts.

Referring to the FIG. 1A, considering the conventional methods and systems illustrating the Tsor-cm timer expire during the ongoing registration process delaying a higher priority PLMN selection and obtaining a service. Further, the method contains following steps:

At step 1, the UE (100) triggers a mobility registration or periodic registration with an access and mobility management function (AMF) entity (200). At step 2, at the same time, the Tsor-cm timer expires in the UE (100). At step 3, the UE (100) waits for completing ongoing registration process.

At step 4, the UE (100) completes the ongoing registration process with the AMF entity (200). At step 5, the UE (100) shall attempt to obtain service on a higher priority PLMN by acting as if timer T that controls periodic attempts has expired. At step 6, the timer waiting for ongoing Registration to complete will add unnecessary delay and signalling before selecting higher priority PLMN

There is another issue in conventional system, where the UE (100) need to initiate a registration on the existing radio connection in below scenario.

The UE (100) received CONFIGURATION UPDATE COMMAND (In generic UE configuration update procedure).

In CONFIGURATION UPDATE COMMAND message, “release of N1 NAS signalling connection not required” is indicated in the signalling connection maintain request.

The UE (100) will initiate registration request procedure on the same radio connection (radio resource control (RRC) connection).

If Tsor-cm timer is expired when the UE (100) received CONFIGURATION UPDATE COMMAND in step 1, if the UE (100) send detach will not allow network to redirect the UE (100).

There is another issue in conventional system where the UE (100) initiate a deregistration procedure but there is no response from the network. This will further delay UE (100) to camp onto the preferred network in the below scenario.

The UE (100) is registered on a fifth generation system (5GS) and Tsor-cm timer expired.

The UE (100) starts T3521 and initiates the deregistration procedure (by sending DEREGISTRATION REQUEST).

If the UE (100) doesn't receive response to the deregistration request, the UE (100) retransmit the DEREGISTRATION REQUEST, On the first four expiries of the timer, the UE (100) shall retransmit the DEREGISTRATION REQUEST message

Timer T3521 value is either 15 sec (wideband (WB)) or 45 second (narrowband (NB)). So, if T3521 is 15 sec, the UE (100) may take additional 60 sec to move to a high priority PLMN.

FIG. 1B illustrating another scenario of Tsor-cm timer expires during the ongoing registration process, according to the prior arts. At step 1, the last running Tsor-cm timer is expired. At step 2a and step 2b, the UE (100) triggers deregistration procedure and starts the timer T3521. There was no response to the sent NAS message. The timer T3521 expires, the UE (100) triggers deregistration procedure again. This cycle continues for 5 times and results in delay in selecting to higher priority PLMN. Timer T3521 value is either 15 sec (WB) or 45 second (NB). So, if T3521 is 15 sec, the UE (100) may take additional 75 sec to move to high priority PLMN (WB) and even longer time of 225 sec in case of NB to move to DEREGISTER state and release N1 signalling connection. Thus it will cause delay in reselecting to higher priority PLMN.

Thus, it is desired to address the above-mentioned disadvantages or other shortcomings or at least provide a useful alternative.

### DISCLOSURE OF INVENTION

### Solution to Problem

The principal object of the embodiments herein is to provide a user equipment (UE) and a method to handle Tsor-cm timer expiry during an ongoing non access stratum (NAS) procedure in a wireless network. The method may be used to ensure that the UE registers over a higher priority PLMN without any delay and extra signalling.

An example embodiment herein is to provide a method for handling timer expiry during an ongoing non-access stratum (NAS) procedure in a wireless network. The method includes detecting, by a user equipment (UE) in the wireless network, that a last running first timer is stopped or expired. Further, the method includes performing, by the UE, a deregistration procedure by sending a deregistration request message to a network entity in the wireless network when the last running first timer is stopped or expired. Further, the method includes starting, by the UE, a second timer. Further, the method includes determining, by the UE, that the deregistration procedure is not successful in first attempt. Further, the method includes aborting, by the UE, the ongoing deregistration procedure upon determining that the deregistration procedure is not successful in the first attempt.

An example embodiment herein is to provide a method for handling timer expiry during an ongoing NAS procedure in a wireless network. The method includes receiving, by a UE, a configuration update command message indicating a registration requested in a registration requested bit of a configuration update indication information element (IE). Further, the method includes detecting, by the UE, a release of an existing N1 NAS signalling connection. Further, the method includes determining, by the UE, whether a last running timer is stopped or expired. Further, the method includes performing, by the UE, one of: attempting to obtain a service on a higher priority public land mobile network (PLMN) by performing a higher priority PLMN selection procedure in response to determining that the last running timer is stopped or expired, and performing a registration procedure for mobility and periodic registration update in response to determining that the last running timer is not stopped or expired.

An example embodiment herein is to provide a UE for handling timer expiry during ongoing NAS procedure in a wireless network. The UE includes at least one processor communicatively coupled to a memory. The processor is configured to detect that a last running first timer is stopped or expired. Further, the processor is configured to perform a deregistration procedure by sending a deregistration request message to a network entity in the wireless network when the last running first is stopped or expired. Further, the processor is configured to start a second timer and determine that the deregistration procedure is not successful in first attempt. Further, the processor is configured to abort the ongoing deregistration procedure upon determining that the deregistration procedure is not successful in the first attempt.

An example embodiment herein is to provide a UE for handling timer expiry during ongoing NAS procedure in a wireless network. The UE includes at least one communicatively coupled to a memory. The processor is configured to receive a configuration update command message indicating a registration requested in a registration requested bit of a configuration update indication information element (IE). Further, the processor is configured to detect a release of an existing N1 NAS signalling connection and determine whether a last running timer is stopped or expired. Further, the processor is configured to perform one of: attempt to obtain a service on a higher priority public land mobile network (PLMN) by performing a higher priority PLMN selection procedure in response to determining that the last running timer is stopped or expired, and perform a registration procedure for mobility and periodic registration update in response to determining that the last running timer is not stopped or expired.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF DRAWINGS

The method and the wireless network are illustrated in the accompanying drawings, throughout which like reference letters indicate corresponding parts in the various figures. The embodiments herein will be better understood from the following description with reference to the drawings, in which:

FIG. 1A illustrating a scenario of Tsor-cm time expires during an ongoing registration process, according to the prior arts;

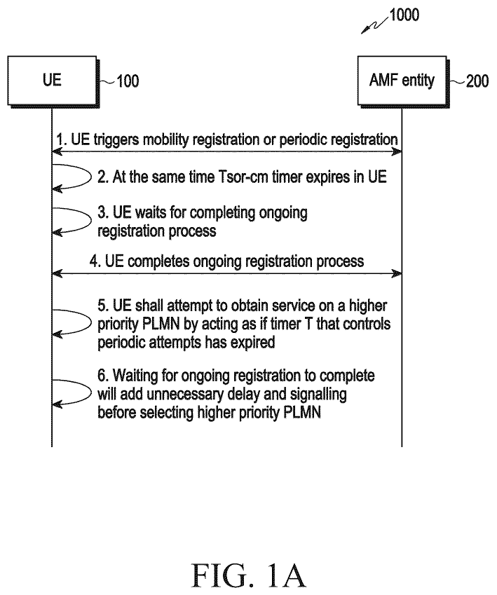

FIG. 1B illustrating another scenario of Tsor-cm time expires during the ongoing registration process, according to the prior arts;

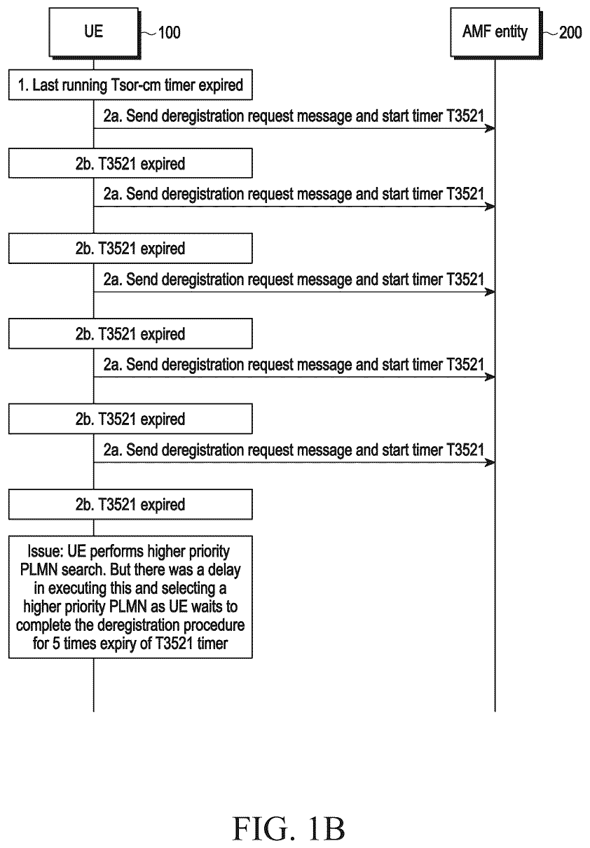

FIG. 2 illustrating a scenario of aborting ongoing registration process, according to the embodiments as disclosed herein;

FIG. 3 illustrating a scenario of completing ongoing registration process, according to the embodiments as disclosed herein;

FIG. 4 illustrating a scenario of aborting ongoing SR or NAS procedure, according to the embodiments as disclosed herein;

FIG. 5 illustrating a scenario of completing ongoing SR or NAS procedure, according to the embodiments as disclosed herein;

FIG. 6 shows various hardware components of a UE, according to the embodiments as disclosed herein;

FIG. 7 is a flow chart illustrating a method for handling Tsor-cm timer expiry during an ongoing NAS procedure in a wireless network upon determining that a deregistration procedure is not successful in first attempt, according to the embodiments as disclosed herein;

FIG. 8 is a flow chart illustrating a method for handling Tsor-cm timer expiry during an ongoing NAS procedure in the wireless network upon determining determining whether a last running Tsor-cm timer is stopped or expired, according to the embodiments as disclosed herein; and

FIG. 9 is a sequence diagram illustrating a method for handling Tsor-cm timer expiry during an ongoing NAS procedure in the wireless network upon determining that the deregistration procedure is not successful in first attempt, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Abbreviations used in the description are as follows:

SoR—CMCI-steering of roaming connected mode control information

SoR—steering of roaming

SR—service request

TAI—tracking area identity

3GPP—3rd generation partnership project

AMF—access and mobility function

PDU—packet data unit

UE—user equipment

Accordingly, the embodiment herein is to provide a method for handling Tsor-cm timer expiry during an ongoing NAS procedure in a wireless network. The method includes detecting, by a UE in the wireless network, that a last running Tsor-cm timer is stopped or expired. Further, the method includes performing, by the UE, a deregistration procedure by sending a deregistration request message to an network entity in the wireless network when the last running Tsor-cm timer is stopped or expired. Further, the method includes starting, by the UE, a T3521 timer. Further, the method includes determining, by the UE, that the deregistration procedure is not successful in first attempt. Further, the method includes aborting, by the UE, the ongoing deregistration procedure upon determining that the deregistration procedure is not successful in the first attempt.

In an embodiment, if the UE determine that the Tsor-cm caused the de-registration procedure then upon the timer T3521 expiry, the UE aborts the de-registration procedure and moves to the idle mode and initiates the high priority PLMN search. If the UE determines that the Tsor-cm caused the de-registration procedure then upon entering to new cell having TAI not in the TAI list then the UE shall abort the de-registration procedure and move to idle mode without initiating re-registration procedure. In an embodiment, if the UE receives UCU with “registration requested” flag, but if any Tsor-cm timer(s) were running and have stopped, the UE attempts to obtain service on a higher priority PLMN (see 3GPP TS 23.122).

Unlike conventional methods and systems, the proposed method may be used to handle Tsor-cm timer expiry during the ongoing NAS procedure. The proposed method provides a scenario of aborting ongoing registration process in case of Tsor-cm timer expiry. Further, the proposed method completes ongoing registration process before higher priority public land mobile network (PLMN) selection. The method may be used to ensure that the UE registers over higher priority PLMN without any delay and extra signalling.

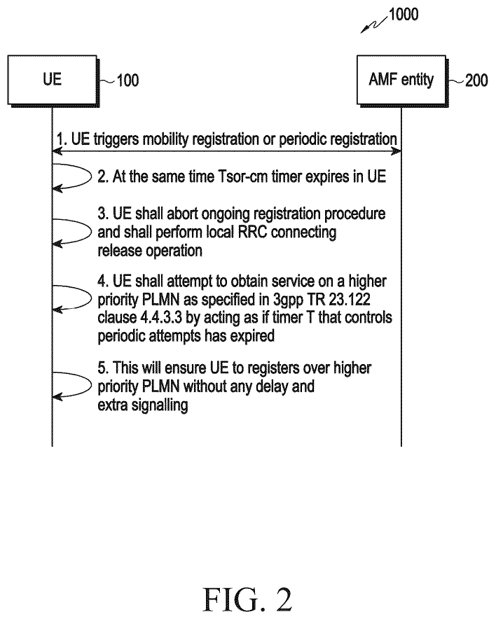

Referring now to the drawings and more particularly to FIGS. 2 through 9, where similar reference characters denote corresponding features consistently throughout the figures, there are shown preferred embodiments.

FIG. 2 illustrating an example scenario of aborting ongoing registration process, according to the embodiments as disclosed herein.

Unlike to the conventional methods and systems, referring to the FIG. 2, considering the proposed method illustrates the scenario of aborting ongoing registration process in case of Tsor-cm timer expiry. The method contains following steps:

At step 1, the UE (100) triggers a mobility registration or periodic registration with an AMF entity (200). At step 2, at the same time, the Tsor-cm timer expires in the UE (100). At step 3, the UE (100) shall abort the ongoing registration procedure and shall perform local RRC connection release operation.

At step 4, The UE (100) shall attempt to obtain service on a higher priority PLMN as specified in 3GPP TR 23.122 clause 4.4.3.3 by acting as if timer T that controls periodic attempts has expired. At step 5, the will ensure the UE (100) to registers over higher priority PLMN without any delay and extra signalling.

In further embodiment, if the cell change into a new tracking area occurs before the registration procedure for mobility and periodic registration update is completed.

In this case, if Tsor-cm timer expired, the registration procedure for the mobility and periodic registration update (or initial registration) shall be aborted and N1 NAS signaling connection shall be released. The UE (100) shall set the 5GS update status to 5U2 NOT UPDATED. The UE (100) shall attempt to obtain service on a higher priority PLMN as specified in the 3GPP TR 23.122 clause 4.4.3.3 by acting as if timer T that controls periodic attempts has expired.

Otherwise, the registration procedure for mobility and periodic registration update shall be aborted and re-initiated immediately. The UE (100) shall set the 5GS update status to 5U2 NOT UPDATED.

In further embodiment, if Transmission failure of REGISTRATION REQUEST message indication from the lower layers or the lower layers indicates that the RRC connection has been suspended with a cell change.

In this case, if Tsor-cm timer is expired, the registration procedure for mobility and periodic registration update (or initial registration) shall be aborted and N1 NAS signaling connection shall be released. The UE (100) shall set the 5GS update status to 5U2 NOT UPDATED. The UE (100) shall attempt to obtain service on a higher priority PLMN as specified in the 3GPP TR 23.122 clause 4.4.3.3 by acting as if timer T that controls periodic attempts has expired.

Otherwise, the registration procedure for mobility and periodic registration update shall be aborted and re-initiated immediately. The UE (100) shall set the 5GS update status to 5U2 NOT UPDATED.

In further embodiment, if the transmission failure of the registration complete message indication with TAI change from lowers layers and if the current TAI is not in the TAI list.

In this case, if Tsor-cm timer is expired, the registration procedure for mobility and periodic registration update (or initial registration) shall be aborted and N1 NAS signaling connection shall be released. The UE (100) shall set the 5GS update status to 5U2 NOT UPDATED. The UE (100) shall attempt to obtain service on a higher priority PLMN as specified in 3GPP TR 23.122 clause 4.4.3.3 by acting as if timer T that controls periodic attempts has expired.

Otherwise, if the current TAI is not in the TAI list, the registration procedure for mobility and periodic registration update shall be aborted and re-initiated immediately. The UE (100) shall set the 5GS update status to 5U2 NOT UPDATED. If the current TAI is still part of the TAI list, it is up to the UE implementation how to re-run the ongoing procedure.

In further embodiment, if the transmission failure of REGISTRATION COMPLETE message indication without TAI change from lower layers.

In this case, if Tsor-cm timer is expired, the registration procedure for mobility and periodic registration update (or initial registration) shall be aborted and N1 NAS signaling connection shall be released. The UE (100) shall set the 5GS update status to 5U2 NOT UPDATED. The UE (100) shall attempt to obtain service on a higher priority PLMN as specified in 3gpp TR 23.122 clause 4.4.3.3 by acting as if timer T that controls periodic attempts has expired.

Otherwise it is up to the UE implementation how to re-run the ongoing procedure.

In further embodiment, if the UE (100) initiated de-registration required.

The de-registration due to removal of universal subscriber identity module (USIM) or entry update in the “list of subscriber data” or due to switch off or due to Tsor-cm timer expiry:

The registration procedure for the mobility and periodic registration update shall be aborted, and the UE (100) initiated de-registration procedure shall be performed.

The de-registration not due to removal of USIM or entry update in the “list of subscriber data” or not due to switch off and not due to Tsor-cm timer expiry:

The UE (100) initiated de-registration procedure shall be initiated after successful completion of the registration procedure for mobility and periodic registration update.

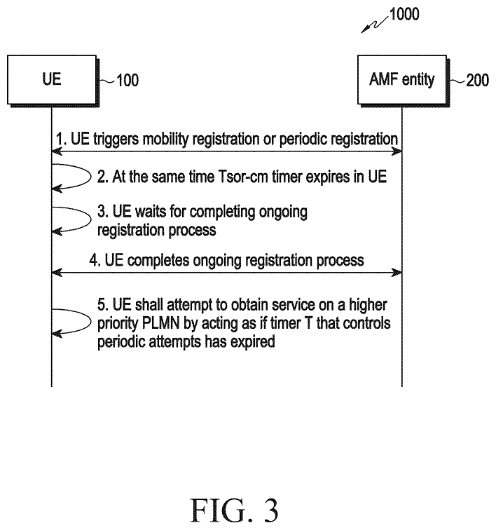

FIG. 3 illustrating a scenario of completing ongoing registration process, according to the embodiments as disclosed herein.

Referring to the FIG. 3, considering the proposed method illustrates the scenario of completing ongoing Registration process before higher priority PLMN Selection. The method contains following steps:

At step 1, the UE (100) triggers mobility registration or periodic registration with the AMF entity (200). At step 2, at the same time, the Tsor-cm timer expires in the UE (100). At step 3, the UE (100) waits for completing ongoing registration process. At step 4, the UE (100) completes the ongoing registration process. At step 5, the UE (100) shall attempt to obtain service on the higher priority PLMN by acting as if timer T that controls periodic attempts has expired.

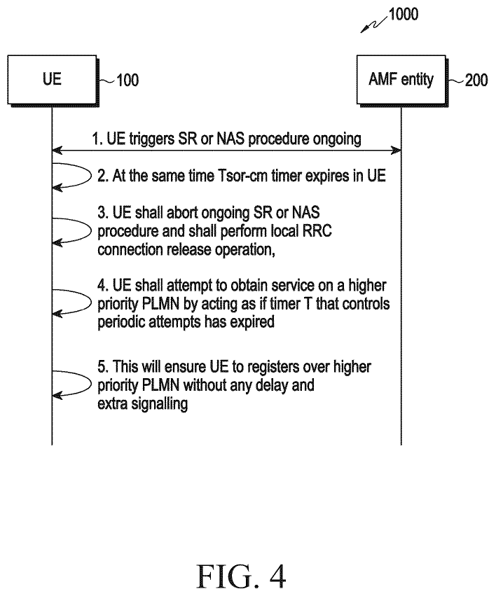

FIG. 4 illustrating a scenario of aborting ongoing SR or NAS procedure, according to the embodiments as disclosed herein.

Referring to the FIG. 4, considering the proposed method illustrates the scenario of aborting ongoing SR or NAS Procedure in case of Tsor-cm timer expiry. The method contains the following steps:

At step 1, the UE (100) triggers the SR or the NAS procedure ongoing with the AMF entity (200). At step 2, at the same time, the Tsor-cm timer expires in the UE (100). At step 3, then, the UE (100) shall abort ongoing SR or NAS procedure and shall perform local RRC connection release operation. At step 4, the UE (100) shall attempt to obtain service on a higher priority PLMN by acting as if timer T that controls periodic attempts has expired. At step 5, the will ensure the UE (100) to registers over higher priority PLMN without any delay and extra signalling.

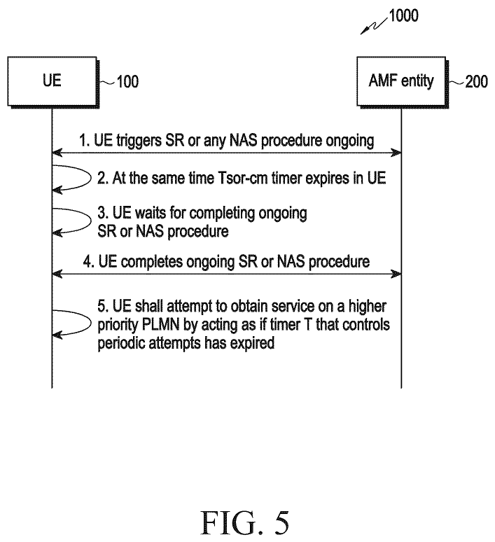

FIG. 5 illustrating a scenario of completing ongoing SR or NAS procedure, according to the embodiments as disclosed herein. Considering the proposed method illustrate the scenario of completing ongoing SR or NAS procedure before higher priority PLMN selection. The method contains following steps:

At step 1, the UE (100) triggers SR or any NAS procedure ongoing. At step 2, at the same time, the Tsor-cm timer expires in the UE (100). At step 3, the UE (100) waits for completing ongoing SR or NAS procedure. At step 4, then the UE (100) completes ongoing SR or NAS procedure. At step 5, the UE (100) shall attempt to obtain service on the higher priority PLMN by acting as if timer T that controls periodic attempts has expired.

In an embodiment, the proposed method also provides a scenario of aborting TAI Change in case of Tsor-cm timer expiry. The method contains following steps:

The UE changes registration area or TAI change happens.

At the same time Tsor-cm timer expires in the UE (100).

The UE (100) shall perform local RRC connection release operation.

The UE (100) shall attempt to obtain service on a higher priority PLMN by acting as if timer T that controls periodic attempts has expired.

This will ensure the UE (100) to registers over higher priority PLMN without any delay and extra signalling.

In an embodiment, the proposed method provides a scenario of completing ongoing TAI Change Procedure before higher priority PLMN selection. The method contains following steps:

The UE (100) changes registration area or TAI change happens.

At the same time Tsor-cm timer expires in the UE (100).

The UE (100) waits for completing ongoing registration request or TAU process for TAI change.

The UE (100) completes ongoing Registration or TAU Procedure.

The UE (100) shall attempt to obtain service on a higher priority PLMN

by acting as if timer T that controls periodic attempts has expired.

If UE (100) has aborted the registration procedure as discussed in this embodiment or not initiated registration procedure then the UE (100) shall enter 5GMM-REGISTERED state and ATTEMPTING-REGISTRATION-UPDATE or PLMN-SEARCH substate and set5GS update status to 5U2 NOT UPDATED. So that if the UE comes back to same PLMN after PLMN selection, the UE (100) remembers that it needs to trigger registration procedure. Or as an implementation option UE may maintain a flag that it needs to trigger registration procedure.

In this embodiment, the UE (100) performs higher priority PLMN selection means, the UE (100) selects higher priority PLMN if below conditions are satisfied:

The UE (100) has a list of available and allowable PLMNs in the area and based on this list or any other implementation specific means, the UE (100) determines that there is a higher priority PLMN than the selected VPLMN; or

The UE (100) does not have a list of available and allowable PLMNs in the area and is unable to determine whether there is a higher priority PLMN than the selected VPLMN using any other implementation specific means;

Then the UE (100) shall attempt to obtain service on a higher priority PLMN by acting as if timer T that controls periodic attempts has expired.

In this specification, Releasing RRC connection, releasing N1 NAS signaling connection and RRC connection abort is used interchangeably.

In this embodiment, Tsor-cm timer expired when UE (100) received CONFIGURATION UPDATE COMMAND (In Generic UE configuration update procedure) and “release of N1 NAS signalling connection not required” is indicated in the Signalling connection maintain request. In this case, the UE (100) shall not send detach request. It should send detach after Registration is successful.

In further embodiment, Tsor-cm timer expired when the UE (100) initiated registration update procedure (Registration procedure for mobility and periodic registration update) was initiated due to CONFIGURATION UPDATE COMMAND (In Generic UE configuration update procedure) and “release of N1 NAS signalling connection not required” is indicated in the Signalling connection maintain request. In this case, the UE (100) shall not send detach request while registration procedure is ongoing. It should send detach after Registration is successful.

In further embodiment, Tsor-cm timer expired when the UE (100) initiated registration update procedure (Registration procedure for mobility and periodic registration update) was initiated due to CONFIGURATION UPDATE COMMAND (In Generic UE configuration update procedure) and “release of N1 NAS signalling connection not required” is indicated in the Signalling connection maintain request. In this case, the UE (100) shall not send detach request and wait for the network command.

In further embodiment, Tsor-cm timer expired when the UE (100) received CONFIGURATION UPDATE COMMAND (In Generic UE configuration update procedure) and “release of N1 NAS signalling connection not required” is indicated in the Signalling connection maintain request. In this case, the UE (100) shall not send detach request and wait for the network command.

In further embodiment, if the UE (100) send registration request when Tsor-cm timer is expired, the UE (100) shall not include Uplink data status.

In further embodiment, if the UE (100) send registration request when Tsor-cm timer is expired, the UE (100) shall include Uplink data status and set all PDU session identifier (PSI) to zero.

In the further embodiment, when the UE (100) aborts/releases N1 signaling connection or network release N1 signaling connection while registration is pending (e.g. UE received configuration update command with re-registration required but UE (100) locally releases N1 NAS signaling connection or network release signaling connection) and the UE initiate high priority PLMN search, the UE (100) enters the substate 5GMM-REGISTERED.ATTEMPTING-REGISTRATION-UPDATE or REGISTERED.PLMN-SEARCH and set 5GS update status to 5U2 NOT UPDATED

In the further embodiment, when deregistration procedure was initiated due to Tsor-cm timer expiry, the de-registration procedure shall be aborted on T3521 timer expiry and the UE (100) proceeds as follows.

If the de-registration type “normal de-registration” was requested for reasons Tsor-cm timer expiry and timer T3521 expired (first T3521 expiry), the UE (100) shall abort N1 NAS signaling connection and enter the 5GMM-DEREGISTERED state.

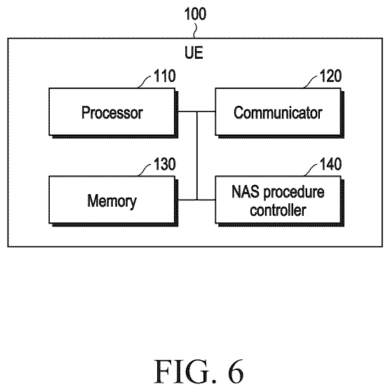

FIG. 6 shows various hardware components of the UE (100), according to the embodiments as disclosed herein. The UE (100) may be, for example, but not limited to a cellular phone, a smart phone, a personal digital assistant (PDA), a tablet computer, a laptop computer, an internet of things (IoT), embedded systems, edge devices, a vehicle to everything (V2X) device or the like. In an embodiment, the UE (100) includes a processor (110), a communicator (120), a memory (130) and a NAS procedure controller (140). The processor (110) is coupled with the communicator (120), the memory (130) and the NAS procedure controller (140).

The NAS procedure controller (140) detects that the last running Tsor-cm timer is stopped or expired. Further, the NAS procedure controller (140) performs the deregistration procedure by sending the deregistration request message to the network entity (e.g., AMF entity or the like) (200) in the wireless network (1000) (e.g., 5G network, ORAN network or the like) when the last running Tsor-cm timer is stopped or expired. Further, the NAS procedure controller (140) starts the T3521 timer and determines that the deregistration procedure is not successful in first attempt. Further, the NAS procedure controller (140) aborts the ongoing deregistration procedure upon determining that the deregistration procedure is not successful in the first attempt.

In an embodiment, the NAS procedure controller (140) determines that deregistration procedure is not successful in the first attempt during at least one of T3521 timer is expired, a change in a current tracking area identity (TAI) and a current TAI is not in the stored TAI list, and transmission failure of a de-registration request message.

In an embodiment, the NAS procedure controller (140) performs at least one of: locally release an established N1 NAS signalling connection during the NAS procedure, performs the local de-registration, and enters into the deregistered state after locally releasing the established N1 NAS signalling connection.

In an embodiment, the NAS procedure controller (140) enters into the idle mode after aborting the ongoing deregistration procedure and initiates the attempt to obtain service on a higher priority public land mobile network (PLMN).

In an embodiment, the NAS procedure controller (140) performs the deregistration procedure when the last running Tsor-cm timer is stopped or expired due to release of a protocol data unit (PDU) session or stop of associated services and the UE is in a connected mode.

In another embodiment, the NAS procedure controller (140) receives the configuration update command message indicating the registration requested in the registration requested bit of the configuration update indication IE. Further, the NAS procedure controller (140) detects the release of the existing N1 NAS signalling connection and determines whether the last running Tsor-cm timer is stopped or expired.

In an embodiment, the NAS procedure controller (140) attempts to obtain the service on the higher priority PLMN by performing the higher priority PLMN selection procedure in response to determining that the last running Tsor-cm timer is stopped or expired. In another embodiment, the NAS procedure controller (140) performs the registration procedure for mobility and periodic registration update in response to determining that the last running Tsor-cm timer is not stopped or expired.

The NAS procedure controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware. In an embodiment, the NAS procedure controller (140) is included in the processor (110).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that may, over time, change (e.g., in Random Access Memory (RAM) or cache).

Although the FIG. 6 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components may be combined together to perform same or substantially similar function in the UE (100).

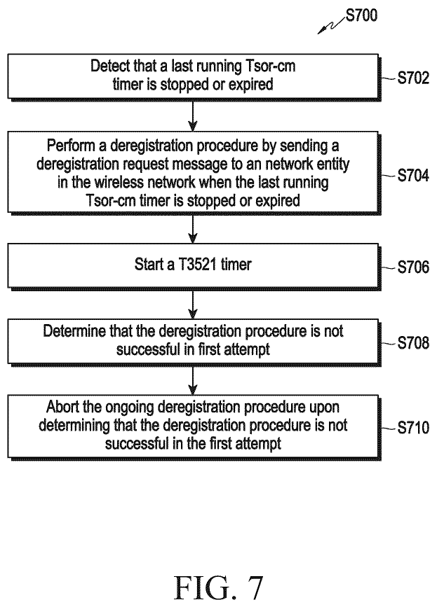

FIG. 7 is a flow chart (S700) illustrating a method for handling Tsor-cm timer expiry during ongoing NAS procedure in the wireless network (1000) upon determining that the deregistration procedure is not successful in first attempt, according to the embodiments as disclosed herein. The operations (S702-S710) are handled by the NAS procedure controller (140).

At S702, the method includes detecting that the last running Tsor-cm timer is stopped or expired. At S704, the method includes performing the deregistration procedure by sending the deregistration request message to the network entity (e.g., AMF entity) (200) in the wireless network (1000) when the last running Tsor-cm timer is stopped or expired. At S706, the method includes starting the T3521 timer. At S708, the method includes determining that the deregistration procedure is not successful in first attempt. At S710, the method includes aborting the ongoing deregistration procedure upon determining that the deregistration procedure is not successful in the first attempt.

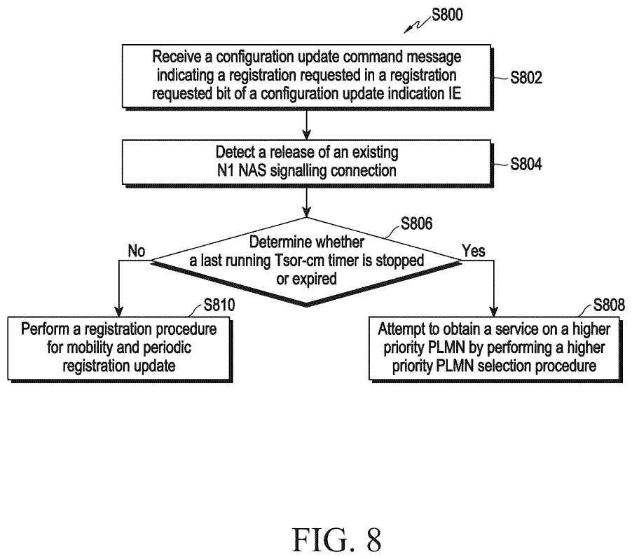

FIG. 8 is a flow chart (S800) illustrating a method for handling Tsor-cm timer expiry during the ongoing NAS procedure in the wireless network (1000) upon determining determining whether the last running Tsor-cm timer is stopped or expired, according to the embodiments as disclosed herein. The operations (S802-S810) are handled by the NAS procedure controller (140).

At S802, the method includes receiving the configuration update command message indicating the registration requested in the registration requested bit of the configuration update indication IE. At S804, the method includes detecting the release of the existing N1 NAS signalling connection. At S806, the method includes determining whether the last running Tsor-cm timer is stopped or expired. In response to determining that the last running Tsor-cm timer is stopped or expired, at S808, the method includes attempting to obtain the service on the higher priority PLMN by performing the higher priority PLMN selection procedure. In response to determining that the last running Tsor-cm timer is not stopped or expired, at S810, the method includes performing the registration procedure for mobility and periodic registration update.

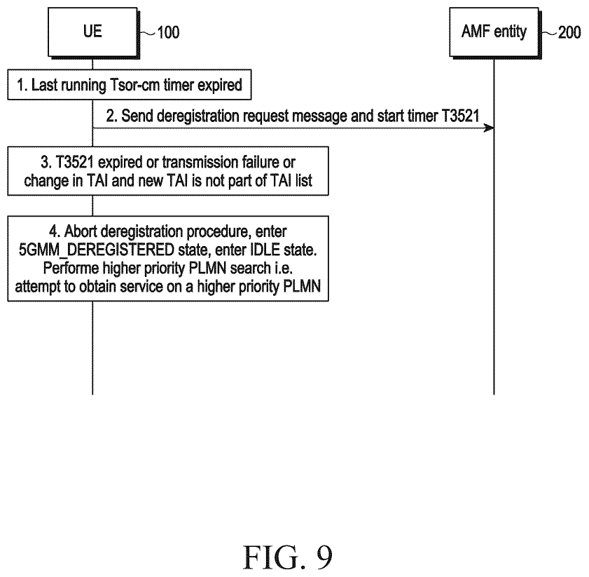

FIG. 9 is a sequence diagram illustrating a method for handling Tsor-cm timer expiry during the ongoing NAS procedure in the wireless network (100) upon determining that the deregistration procedure is not successful in first attempt, according to the embodiments as disclosed herein.

At step 1, the last running Tsor-cm timer is expired. At step 2, The UE (100) triggers deregistration procedure and starts the timer T3521. At step 3, the UE (100) determines failure of deregistration procedure in the first attempt for example when guard timer like timer T3521 expired (for e.g., it may be any guard timer) or the transmission failure or change in TAI and new TAI is not part of TAI list. At step 4, the UE (100) abort the deregistraton procedure, enter 5GMM DEREGISTERED state, locally release an established N1 NAS signalling connection, enter IDLE state. Perform higher priority PLMN search i.e. attempt to obtain service on the higher priority PLMN. This avoids any delay in selecting higher priority PLMN.

The method can be used to ensure that the UE registers over higher priority PLMN without any delay and extra signalling.

The various actions, acts, blocks, steps, or the like in the flow charts (S700 and 800) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for handling timer expiry during an ongoing non-access stratum (NAS) procedure in a wireless network, comprising:
detecting, by a user equipment (UE) in the wireless network, that a last running first timer is stopped or expired;
performing, by the UE, a deregistration procedure by sending a deregistration request message to a network entity in the wireless network when the last running first timer is stopped or expired;
starting, by the UE, a second timer;
determining, by the UE, that the deregistration procedure is not successful in first attempt; and
aborting, by the UE, the ongoing deregistration procedure upon determining that the deregistration procedure is not successful in the first attempt.

2. The method as claimed in claim 1, wherein the UE determines that the deregistration procedure is not successful in the first attempt during at least one of the second timer is expired, a change in a current tracking area identity (TAI) and the current TAI is not in a TAI list, and transmission failure of the deregistration request message.

3. The method as claimed in claim 1, wherein the method further comprises performing at least one of:
locally releasing, by the UE, an established N1 NAS signalling connection during the NAS procedure and entering into a deregistered state; and
performing, by the UE, a local de-registration and entering into the deregistered state.

4. The method as claimed in claim 1, wherein the method further comprises:
entering, by the UE, into an idle mode after aborting the ongoing deregistration procedure; and
initiating, by the UE, an attempt to obtain service on a higher priority public land mobile network (PLMN).

5. The method as claimed in claim 1, wherein the UE performs the deregistration procedure when the last running first timer is stopped or expired due to release of a protocol data unit (PDU) session or stop of associated services.

6. A method for handling timer expiry during an ongoing non-access stratum (NAS) procedure in a wireless network, comprising:
receiving, by a UE, a configuration update command message indicating a registration requested in a registration requested bit of a configuration update indication information element (IE);
detecting, by the UE, a release of an existing N1 NAS signalling connection;
determining, by the UE, whether a last running first timer is stopped or expired; and
performing, by the UE, one of:
attempting to obtain a service on a higher priority public land mobile network (PLMN) by performing a higher priority PLMN selection procedure in response to determining that the last running timer is stopped or expired, and
performing a registration procedure for mobility and periodic registration update in response to determining that the last running timer is not stopped or expired.

7. A UE for handling timer expiry during ongoing non-access stratum (NAS) procedure in a wireless network, wherein the UE comprises:
a memory; and
at least one processor communicatively coupled to the memory, configured to:
detect that a last running first timer is stopped or expired;
perform a deregistration procedure by sending a deregistration request message to a network entity in the wireless network when the last running first timer is stopped or expired;
start a second timer;
determine that the deregistration procedure is not successful in first attempt; and
abort the ongoing deregistration procedure upon determining that the deregistration procedure is not successful in the first attempt.

8. The UE as claimed in claim 7, wherein the UE determines that the deregistration procedure is not successful in the first attempt during at least one of the second timer is expired, a change in a current tracking area identity (TAI) and a current TAI is not in a TAI list, and transmission failure of the deregistration request message;

9. The UE as claimed in claim 7, wherein the processor is further configured to perform at least one of:
locally release an established N1 NAS signalling connection during the NAS procedure;
perform a local de-registration; and
enter into a deregistered state after locally releasing the established N1 NAS signalling connection.

10. The UE as claimed in claim 7, wherein the processor is further configured to:
enter into an idle mode after aborting the ongoing deregistration procedure; and
initiate an attempt to obtain service on a higher priority public land mobile network (PLMN).

11. The UE as claimed in claim 7, wherein the processor is further configured to perform the deregistration procedure when the last running first timer is stopped or expired due to release of a protocol data unit (PDU) session or stop of associated services and the UE is in a connected mode.

12. UE for handling first timer expiry during ongoing non-access stratum (NAS) procedure in a wireless network, wherein the UE comprises:
a memory; and
a processor communicatively coupled to the memory, configured to:
receive a configuration update command message indicating a registration requested in a registration requested bit of a configuration update indication information element (IE);
detect a release of an existing N1 NAS signalling connection;
determine whether a last running timer is stopped or expired; and
perform one of:
attempt to obtain a service on a higher priority public land mobile network (PLMN) by performing a higher priority PLMN selection procedure in response to determining that the last running timer is stopped or expired, and
perform a registration procedure for mobility and periodic registration update in response to determining that the last running timer is not stopped or expired.
